(19) United States
(12) Patent Application Publication
(10) Pub. No.: US 2018/0189841 A1
(43) Pub. Date: Jul. 5, 2018

(54) ELECTRONIC APPARATUS AND CONTROLLING METHOD THEREOF

(71) Applicant: SAMSUNG ELECTRONICS CO., LTD., Suwon-si (KR)

(72) Inventors: Hee-ran LEE, Suwon-si (KR); Do-sung KIM, Hwaseong-si (KR); Sung-won KIM, Seongnam-si (KR); Mu-gong BAE, Suwon-si (KR); Seung-min SHIN, Seoul (KR); Hyun-don YOON, Pohang-si (KR)

(73) Assignee: SAMSUNG ELECTRONICS CO., LTD., Suwon-si (KR)

(21) Appl. No.: 15/858,674

(22) Filed: Dec. 29, 2017

(30) Foreign Application Priority Data
Jan. 3, 2017 (KR) 10-2017-0000607

(51) Int. Cl. G06Q 30/02

(52) U.S. Cl. CPC G06Q 30/0271; G06Q 30/0255; G06Q 30/0253

(57) ABSTRACT

An electronic apparatus is disclosed. The electronic apparatus includes a communicator configured to communicate with a display apparatus; a storage configured to store purchase history information; and a processor configured to control the communicator to transmit advertisement information which is determined based on the purchase history information to the display apparatus, wherein the processor is further configured to receive first characteristic information corresponding to a first image displayed on the display apparatus from the display apparatus through the communicator, determine whether the first image is related to payment for a product purchase based on the received first characteristic information, and if the first image is related to payment for a product purchase, update the purchase history information.

### CROSS-REFERENCE TO RELATED APPLICATIONS

This application claims priority from Korean Patent Application No. 10-2017-0000607, filed on Jan. 3, 2017 in the Korean Intellectual Property Office, the disclosure of which is incorporated herein by reference in its entirety.

### BACKGROUND

### 1. Field

Devices and methods consistent with what is disclosed herein relate to an electronic apparatus and a controlling method thereof, and more particularly, to an electronic apparatus capable of providing advertisement information based on purchase history information and a controlling method thereof.

### 2. Description of the Related Art

User demand for purchasing has been gradually diversified. With the development of electronic technology, a television (TV) which was conventionally used only for broadcasting, is now used for various purposes according to the usage mode and transmission mode. In particular, new industries have been mass-produced by the combination of broadcasting and communication (e.g., Internet).

In addition, various activities such as Internet surfing, purchasing goods and playing games have become possible through display devices such as a smart TV capable of two-way communication with a server, a computer, and a portable device, and the development of the advertisement industry through TV has also been accelerated.

In recent years, a service that analyzes users' preferences and provides customized advertisements to the TV has been introduced. In order to provide appropriate customized advertisement, sufficient and diverse data is required to analyze users' preferences accurately, and various methods have been introduced to collect such data.

### SUMMARY

One or more exemplary embodiments provide an electronic apparatus capable of providing advertisement information based on purchase history information and a controlling method thereof.

According to an aspect of an exemplary embodiment, there is provided an electronic apparatus including: a communicator configured to communicate with a display apparatus; a storage configured to store purchase history information; and a processor configured to control the communicator to transmit advertisement information which is determined based on the purchase history information to the display apparatus, wherein the processor is further configured to receive first characteristic information corresponding to a first image displayed on the display apparatus from the display apparatus through the communicator, determine whether the first image is related to payment for a product purchase based on the received first characteristic information, and if the first image is related to payment for a product purchase, update the purchase history information.

The first characteristic information may include at least one of a capture image which is generated by capturing the first image, information regarding a fingerprint corresponding to the first image, information regarding a text included in the first image, and information regarding a logo included in the first image.

If the first image is related to payment for a product purchase and product information is acquired from the first characteristic information, the processor may update the purchase history information based on the acquired product information.

The communicator may receive at least one piece of second characteristic information corresponding to at least one second image which is displayed before the first image, and if the first image is related to payment for a product purchase and product information is not acquired from the first characteristic information, the processor acquires product information from the received at least one piece of the second characteristic information and updates purchase history information based on the acquired product information.

The storage may further store viewing history information corresponding to the display apparatus, and the processor updates the viewing history information based on the received first characteristic information, and controls the communicator to transmit advertisement information which is determined based on the updated viewing history information and the updated purchase history information to the display apparatus.

The purchase history information may include information regarding at least one of a product name, a product manufacturer, a product category, a product price, and a means of payment.

The storage may store a plurality of different pieces of purchase history information respectively corresponding to a plurality of display apparatuses including the display apparatus, and the processor transmits a plurality of different pieces of advertisement information to each of the plurality of display apparatuses through the communicator based on the plurality of different pieces of purchase history information.

The purchase history information may include at least two of home-shopping purchase history information, application purchase history information, game item purchase history information, Video On demand (VOD) purchase history information, and pay TV history information.

According to an aspect of an exemplary embodiment, there is provided a controlling method of an electronic apparatus, including: receiving first characteristic information corresponding to a first image displayed on a display apparatus from the display apparatus; in response to determining that the first image is related to payment for a product purchase based on the received first characteristic information, updating pre-stored purchase history information; and transmitting advertisement information which is determined based on the updated purchase history information to the display apparatus.

The first characteristic information may include at least one of a capture image which is generated by capturing the first image, information regarding a fingerprint corresponding to the first image, information regarding a text included in the first image, and information regarding a logo included in the first image.

The updating may include, if the first image is related to payment for a product purchase and product information is acquired from the first characteristic information, updating the purchase history information based on the acquired product information.

The method may further include: receiving at least one piece of second characteristic information corresponding to at least one second image which is displayed before the first image, wherein the updating includes, if the first image is related to payment for a product purchase and product information is not acquired from the first characteristic information, acquiring product information from the received at least one piece of the second characteristic information and updating purchase history information based on the acquired product information.

The method may further include: updating pre-stored viewing history information corresponding to the display apparatus based on the received first characteristic information, wherein the transmitting includes transmitting advertisement information which is determined based on the updated viewing history information and the updated purchase history information to the display apparatus.

The purchase history information may include information regarding at least one of a product name, a product manufacturer, a product category, a product price, and a means of payment.

The method may further include storing a plurality of different pieces of purchase history information respectively corresponding to a plurality of display apparatuses including the display apparatus, wherein the transmitting includes transmitting a plurality of different pieces of advertisement information to each of the plurality of display apparatuses based on the plurality of different pieces of purchase history information.

The purchase history information may include at least two of home-shopping purchase history information, application purchase history information, game item purchase history information, Video On demand (VOD) purchase history information, and pay TV history information.

According to an aspect of another exemplary embodiment, there is provided a non-transitory computer readable recording medium including a program for performing a controlling method of an electronic apparatus, wherein the controlling method includes: receiving first characteristic information corresponding to a first image displayed on a display apparatus from the display apparatus; in response to detecting that the first image is related to payment for a product purchase based on the received first characteristic information, updating pre-stored purchase history information; and transmitting advertisement information which is determined based on the updated purchase history information to the display apparatus.

### BRIEF DESCRIPTION OF THE DRAWINGS

The above and/or other aspects will be more apparent by describing certain exemplary embodiments with reference to the accompanying drawings, in which:

FIG. 1 is a block diagram provided to explain an information providing system according to an exemplary embodiment;

FIG. 2 is a block diagram provided to explain an electronic apparatus according to an exemplary embodiment;

FIGS. 3, 4 and 5 are views provided to explain various exemplary embodiments regarding purchase history information update;

FIG. 6 is a view provided to explain an exemplary embodiment regarding generation of specific information corresponding to an image;

FIG. 7 is a view provided to explain data processing flow in an electronic apparatus according an exemplary embodiment;

FIG. 8 is a view provided to explain advertisement information provided in a display apparatus according to an exemplary embodiment;

FIG. 9 is a flowchart provided to explain a controlling method of an electronic apparatus according to an exemplary embodiment; and

FIG. 10 is a block diagram provided to explain a display apparatus according to an exemplary embodiment.

### DETAILED DESCRIPTION OF EXEMPLARY EMBODIMENTS

The terms used below are defined in consideration of the functions of the present disclosure, which may vary depending on the intention of the user, the operator, or the like. Therefore, the definition should be based on the contents throughout this specification.

The terms such as “first,” “second,” and so on may be used to describe a variety of elements, but the elements should not be limited by these terms. The terms are used simply to distinguish one element from other elements.

The terms used herein are solely intended to explain a specific exemplary embodiment, and not to limit the scope of the present disclosure. Singular forms are intended to include plural forms unless the context clearly indicates otherwise. In the present application, the terms “include” and “comprise” designate the presence of features, numbers, steps, operations, components, elements, or a combination thereof that are written in the specification, but do not exclude the presence or possibility of addition of one or more other features, numbers, steps, operations, components, elements, or a combination thereof. The expression, “at least one of a, b, and c,” should be understood as including only a, only b, only c, both a and b, both a and c, both b and c, or all of a, b, and c.

In the exemplary embodiment, ‘module’ or ‘sub’ performs at least one function or operation, and may be implemented in hardware or software, or in a combination of hardware and software. In addition, a plurality of ‘modules’ or ‘units’ may be integrated into at least one module and may be realized as at least one processor in an integrated manner except for ‘modules’ or ‘units’ that should be realized in specific hardware.

Certain exemplary embodiments are described in detail below with reference to the accompanying drawings.

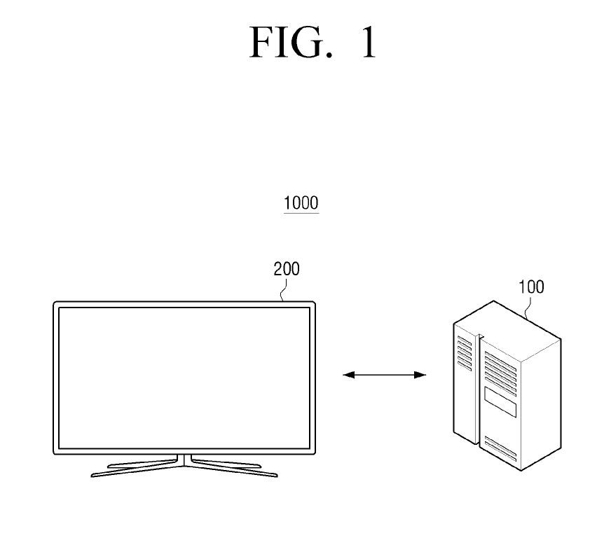

FIG. 1 is a block diagram provided to explain an information providing system according to an exemplary embodiment.

Referring to FIG. 1, an information providing system 1000 includes an electronic apparatus 100 and a display apparatus 200.

The display apparatus 200 may display an image corresponding to a content. For example, the display 200 may be an electronic apparatus such as TV, personal computer (PC), mobile phone, personal digital assistant (PDA), and the like.

The content refers to a media object which can be viewed on the display apparatus 200. For example, the content may be divided into live broadcasting contents, digital video recorder (DVR) contents, Video On Demand (VOD)/Over The Top (OTT) Non-linear contents, User Generated Contents (UGC), etc. depending on the type of sources which provide the contents.

The display apparatus 200 may acquire characteristic information from a content which is being output. The characteristic information may be, for example, a text included in an image corresponding to a content, a logo included in an image, a trademark, a video fingerprint corresponding to an image, or an audio fingerprint acquired from an audio of a content. In addition, the characteristic information may be an image which is generated by capturing an image corresponding to a content.

The fingerprint is characteristic information acquired from an image signal or an audio signal, and unlike metadata which is based on a text, reflects characteristics inherent in the media signal itself. For example, the audio fingerprint acquired from an audio signal may be information indicating characteristics such as frequency and amplitude of the audio signal, and the video fingerprint acquired from an image signal may be information indicating characteristics such as motion vector, color and the like of the image signal. Such fingerprints may be used in Automatic Contents Recognition (ACR) technology.

The display apparatus 200 can communicate with the electronic apparatus 100, and may transmit characteristic information acquired from a content to the electronic apparatus 100 and receive advertisement information from the electronic apparatus 100. Here, the advertisement may be a customized advertisement, and may reflect the preference of a user of the display apparatus 200. The advertisement information may be for guiding the purchase of goods, VOD, game, etc.

The display apparatus 200 may provide received advertisement information. For example, the display apparatus 200 may display a graphic user interface corresponding to the received advertisement information.

The electronic apparatus 100 may transmit advertisement information to the display apparatus 200 based on the purchase history information of the user of the display apparatus 200.

Specifically, the electronic apparatus 100 may store the purchase history information of the user of the display apparatus 200 and transmit advertisement information to the display apparatus 200 based on the purchase history information. Here, the purchase history information is information reflecting the purchase activity information of the user of the display apparatus 200. The information includes, for example, a history of purchasing a product through a website, a history of purchasing a product through a home shopping, and a history of purchase of products at a store. The electronic apparatus 100 may request another electronic apparatus managing the information to collect purchase history information, or may collect purchase history information from the electronic apparatuses. For example, when the purchase is made through the display apparatus 200, the electronic apparatus 100 receives various purchase related information (for example, information input by the user into the display apparatus 200, characteristic information regarding an image displayed on the display apparatus 200, and the like), and collect purchase history information.

The purchase history information may include at least one of product name of a purchased product, a product manufacturer, a product category, a product prices, a product seller, a product sales broker, a payment means used to pay for a product, a payment time, and the like. The purchase history information includes not only information on the case of purchasing a product by paying money but also information on the case of acquiring a free product.

The electronic apparatus 100 may determine whether an image displayed on the display apparatus 200 is related to payment to purchase a product based on characteristic information regarding the image. Here, the product includes anything that is the subject of a transaction. If the image displayed on the display apparatus 200 is related to payment to purchase a product, the electronic apparatus 100 may update the purchase history information corresponding to the display apparatus 200.

In this way, the electronic apparatus 100 may provide a customized advertisement to the display apparatus 200 based on the preference of the user of the display apparatus 200. In other words, the electronic apparatus 100 does not provide advertisement information at random, but may provide advertisement information by targeting a user of a display apparatus who is likely to be interested in the corresponding advertisement information.

FIG. 1 illustrates one electronic apparatus 100, but there may be a plurality of electronic apparatuses.

In addition, FIG. 1 illustrates that the electronic apparatus 100 communicates with one display apparatus 200, but the electronic apparatus 100 may communicate with a plurality of display apparatuses. In this case, the electronic apparatus 100 may store a plurality of different pieces of purchase history information corresponding to each of the plurality of display apparatuses, and transmit a plurality of different pieces of advertisement information to the plurality of display apparatuses based on the plurality of different pieces of purchase history information.

According to the above exemplary embodiment, the display apparatus 200 transmits characteristic information directly to the electronic apparatus 100, and the electronic apparatus 100 transmits advertisement information directly to the display apparatus 200, but the characteristic information may be transmitted to the electronic apparatus 100 via another intermediate medium, and/or the advertisement information may be transmitted to the display apparatus 200 via another intermediate medium.

Hereinafter, the display apparatus 200 and the electronic apparatus 100 according to an exemplary embodiment will be described in greater detail.

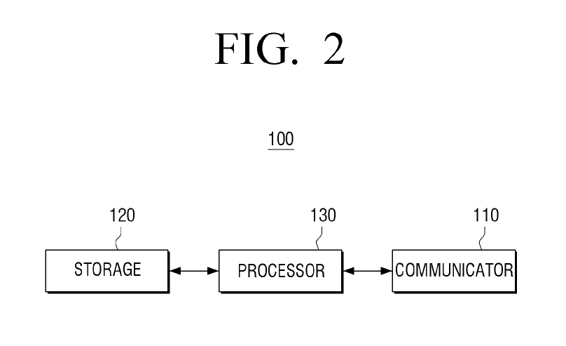

FIG. 2 is a block diagram provided to explain configuration of the electronic apparatus 100 according to an exemplary embodiment. The electronic apparatus 100 may be implemented, for example, as a server for providing advertisement.

Referring to FIG. 2, the electronic apparatus 100 includes a communicator 110, a storage 120 and a processor 130.

The communicator 110 is a communication interface, such as a transceiver, configured to perform communication with a variety of external apparatuses. The communicator 110 may be connected to external apparatuses via a local area network (LAN), an Internet network, or wireless communication network (e.g., Z-wave, 4LoWPAN, RFID, LTE D2D, BLE, GPRS, Weightless, Edge Zigbee, ANT+, NFC, IrDA, DECT, WLAN, Bluetooth, Wi-Fi, Wi-Fi Direct, GSM, UMTS, LTE and WiBRO). The communicator 110 may include various communication chips such as a Wi-Fi chip, a Bluetooth chip, and a wireless communication chip.

The communicator 110 may receive various information including characteristic information from the display apparatus 200 and transmit various information including advertisement information to the display apparatus 200.

The storage 120 may store various programs and data which are necessary to operate the electronic apparatus 100.

The storage 120 may be implemented as non-volatile memory, volatile memory, flash memory, hard disk drive (HDD) or solid state drive (SSD). The storage 120 may be accessed by the processor 130 and may read/record/correct/delete/update data under the control of the controller 130. The storage 120 may be realized as a recording medium within the electronic apparatus 100 or as an external storage medium, such as a USB or a web server via network, etc. The storage 120 may store programs such as O/S or various applications and various data such as user setting data, data generated in the process of executing an application, multimedia content data, etc.

The storage 120 may store the purchase history information of the user of the display apparatus 200. The storage 120 may store a plurality of pieces of purchase history information regarding each of a plurality of users including the user of the display apparatus 200, and the electronic apparatus 100 may provide advertisement information based on the corresponding purchase history information to not only the display apparatus 200 but also other display apparatuses. In this case, the purchase history information may be stored by being categorized by user or display apparatus.

The processor 130 may control the overall operations of the electronic apparatus 100. The processor 130 may include a Central Processing Unit (CPU), a Random Access Memory (RAM), a Read Only Memory (ROM), and a system bus. According to the above exemplary embodiment, the processor 130 includes only one CPU, but the processor 130 may be implemented to include a plurality of CPUs (or Digital Signal Processor (DSP), Micro Processor Unit (MPU), etc.)

The processor 130 may control the communicator 110 to transmit advertisement information corresponding to the purchase history information of a specific user stored in the storage 120 to the display apparatus 200 of the specific user.

The processor 130 may receive characteristic information corresponding to the image displayed on the display apparatus 200 from the display apparatus 200 through the communicator 110 and confirm whether the image displayed on the display apparatus 200 is related to payment for a product purchase based on the received characteristic information. If it is confirmed that the image displayed on the display apparatus 200 is related to payment for a product purchase, the processor 130 may update the purchase history of the user of the display apparatus 200, which is stored in the storage 110.

The image related to payment for a product purchase may be any image showing the user's interest in purchasing the product. For example, it may be an image displayed when a user inputs a command to purchase a product through the display apparatus 200 (for example, when the ‘order’ button is selected). The image related to payment for a product purchase may be an image displayed in the payment process (for example, an image including a user interface (UI) for inputting a shipping address, the number of purchased products, a UI for selecting a payment means, etc.). The image related to payment for a product purchase may be an image displayed when the payment is completed.

Updating the purchase history information may refer to adding information related to new purchase to the existing purchase history information, or replacing some or all of the existing purchase history information with information related to new purchase. Updating the purchase history information corresponding to the display apparatus 200 may also include generating and storing new purchase history information in a state where there is no purchase history information corresponding to the display apparatus 200.

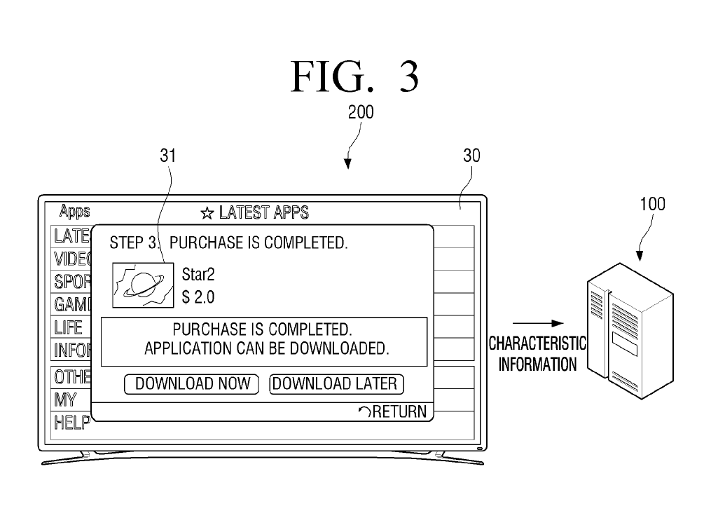

FIG. 3 is a view provided to explain purchase history information update of the electronic apparatus 100 according to an exemplary embodiment.

The display apparatus 200 may transmit characteristic information regarding an image displayed on the display apparatus 200 to the electronic apparatus 100 at predetermined intervals or upon occurrence of a specific event.

FIG. 3 illustrates that product purchase has been completed through the display apparatus 200 and thus, an image 30 including a window which indicates the completion of product purchase is displayed. In this state, the display apparatus 200 transmits characteristic information regarding the currently-displayed image 30 to the electronic apparatus 100.

Here, the characteristic information is information which may identify an image displayed on the display apparatus 200. For example, the characteristic information may include at least one of a captured image generated by capturing an image displayed on the display apparatus 200, information regarding fingerprint corresponding to the image, information regarding a text included in the image and information regarding a logo included in the image, metadata of the mage, ID code designated to the image, information regarding a UI included in the image, etc.

The processor 130 may determine whether the image 30 displayed on the display apparatus 200 is related to payment for a product purchase based on the characteristic information received from the display apparatus 200.

For example, if the received characteristic information includes information regarding a text included in the image 30, the processor 130 may identify whether the image 30 is related to payment through keyword recognition. Specifically, the processor 130 may identify that the image 30 is related to payment by recognizing keywords such as “$”, “purchase”, “completion”, “now”, “download”, etc.

In another example, if the received characteristic information is information regarding a UI included in the image 30, and the information indicates that the UI is a payment completion UI, the processor 130 may confirm that the image 30 which is currently displayed on the display apparatus 200 is related to payment for a product purchase based on the characteristic information.

In another example, if the received characteristic information includes a logo included in the image 30 or information regarding a trademark and a text included in the image 30, the processor 130 may confirm that the image 30 which is currently displayed on the display apparatus 200 is related to application payment for a product purchase through the trademark “Apps” and the text “purchase.”

If the received characteristic information is a captured image generated by capturing the image 30, the processor 130 may identify the captured image using technologies such as deep learning technology, Convolutional Neural Network (CNN), Recurrent Neural Network (RNN), etc.

In addition to the above-described examples, the processor 130 may identify that the image 30 is related to payment for a product purchase in various ways.

The processor 130 may acquire product information from the characteristic information regarding the image 30 and update purchase history information of the user of the display apparatus 200 based on the acquired product information.

For example, if the received characteristic information includes information regarding a text included in the image 30, the processor 130 may acquire product information through keyword recognition. Specifically, the processor 130 may confirm that a purchase target product in the image 30 is a game application called “Star 2” by recognizing the keyword of “Star 2.”

In another example, if the received characteristic information includes information regarding a video fingerprint corresponding to image 30, the processor 130 may acquire product information by comparing a pre-stored fingerprint with a received fingerprint. Specifically, by comparing a pre-stored fingerprint with a received fingerprint, the processor 130 may identify that a thumbnail image 31 corresponding to a game application called “Star 2” is included in the image 30 and thus, confirm that the purchase target product is the game application called “Star 2.”

In another example, if the received characteristic information is a captured image generated by capturing the image 30, the processor 130 may analyze the capture image using the deep learning technology to identify that the purchase target product is the game application called “Star 2.”

In addition to the above-described examples, the processor 130 may acquire product information from characteristic information, which is received from the display apparatus 200, in various ways.

The processor 130 may update the purchase history information of the user of the display apparatus 200 based on the acquired product information. For example, the processor 130 may reflect information regarding the game application called “Star 2” on the purchase history information of the display apparatus 200.

FIG. 3 illustrates that the purchase history information of the electronic apparatus 100 is updated when the image indicating that payment is completed is displayed, but it is not limited thereto. For example, the purchase history information of the electronic apparatus 100 may be updated even when the image of payment process (for example, an image including a UI for selecting a payment means or an image including a UI for inputting shipping information) is displayed. This is because even if the user of the display apparatus 200 does not finally purchase the product, the user is interested in the product to some extent as the image including a UI for selecting a payment means or the image including a UI for inputting shipping information is displayed in the display apparatus 200. Accordingly, the purchase history information of the user of the display apparatus 200 may reflect not only the case where the user of the display apparatus 200 finally completes the purchasing process but also the case where the user at least attempts to purchase a product.

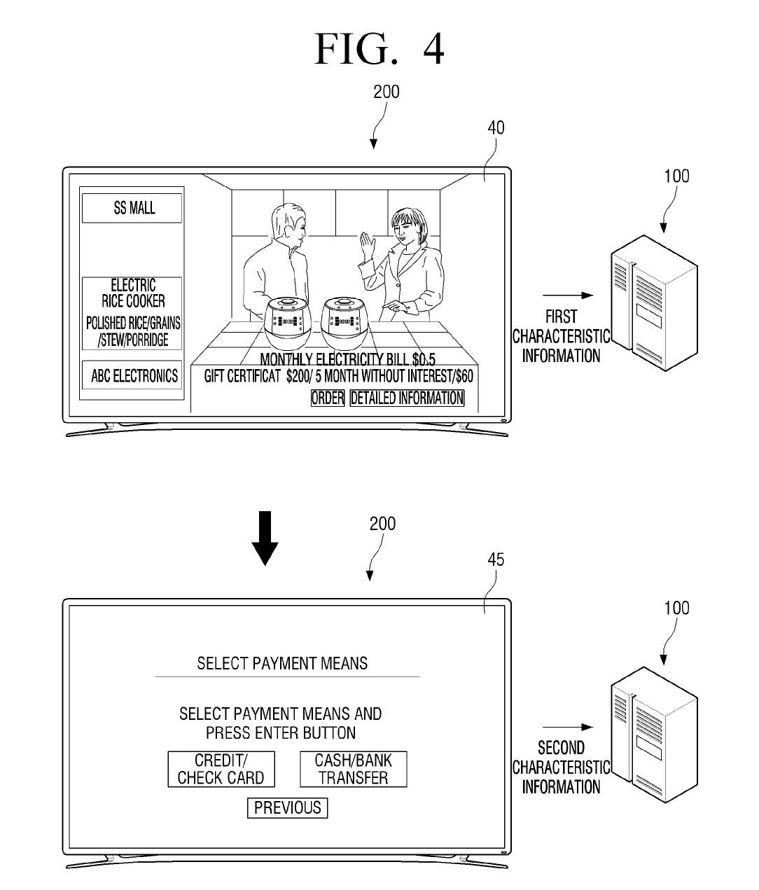

FIG. 3 illustrates the case where it is possible to identify whether an image is related to payment for a product purchase or identify a target product of purchase, through one image. By contrast, when it is not possible to identify the above through only one image, the processor 130 may identify the above based on a plurality of images, which will be described I detail with reference to FIG. 4.

FIG. 4 is a view provided to explain purchase history information update of the electronic apparatus 100 according to another exemplary embodiment.

The electronic apparatus 100 may identify an image displayed on the display apparatus 200 in real time by periodically receiving characteristic information from the display apparatus 200. Referring to FIG. 4, the display apparatus 200 may transmit first characteristic information regarding a shopping image 40 to the electronic apparatus 100. Then, the display apparatus 200 may transmit second characteristic information regarding an image 45 for selecting a payment means, which is displayed when an order button 41 is selected, to the electronic apparatus 100.

The processor 130 may confirm that the image 45 for payment means selection is related to payment based on the second characteristic information, but product information is not acquired from the second characteristic information. In this case, the processor 130 may acquire the product information from at least one characteristic information corresponding to at least one image which was displayed before the image 45. For example, in the case of FIG. 4, the processor 130 may acquire the product information from the first characteristic information regarding the shopping image 40.

The first characteristic information may include text information such as “electric rice cooker”, “ABC electronics”, “$60”, etc. The processor 130 may acquire product information from the first characteristic information through a keyword recognition technology, etc.

In another example, the first characteristic information may include information regarding a fingerprint corresponding to the shopping image 40, and the processor 130 may determine that the shopping image 40 is a shopping image for an electric rice cooker of ABC electronics which is broadcast on a home shopping channel of SS Mall by comparing the received fingerprint with a pre-stored fingerprint.

The processor 130 may also acquire information regarding a purchase target product included in the shopping image 40 by using the deep learning technology.

The processor 130 may update purchase history information of the user through the display apparatus 200 based on the product information acquired through the first characteristic information.

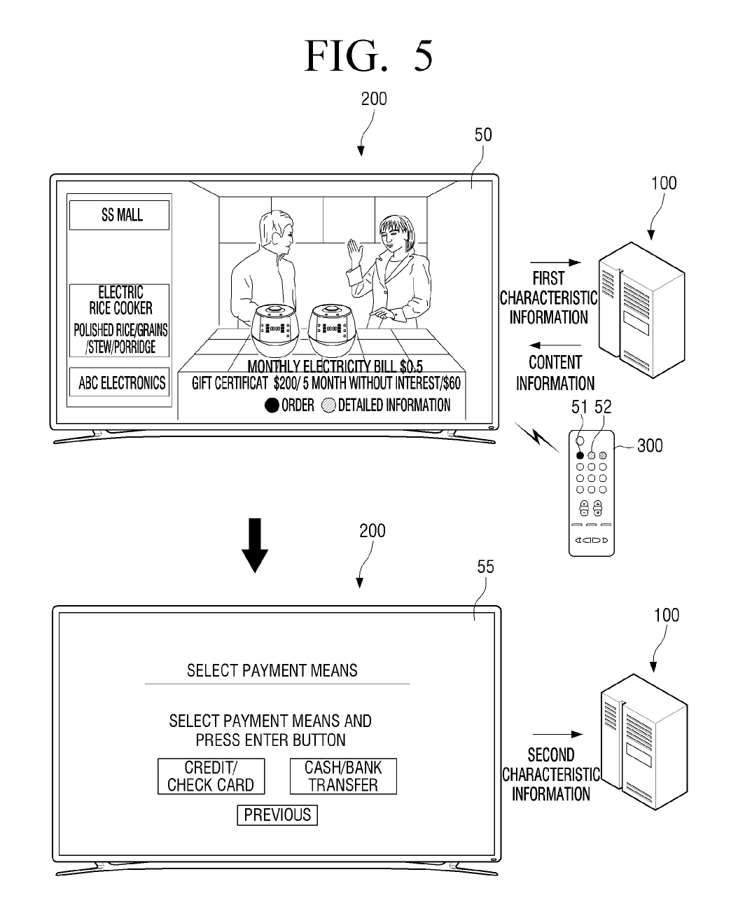

In the above exemplary embodiments, information regarding the image itself may be used to confirm whether the image displayed on the display apparatus 200 is related to payment for a product purchase. However, according to another exemplary embodiment, a user command which is input to the display apparatus 200 may also be used to confirm whether the image displayed on the display apparatus 200 is related to payment for a product purchase, which will be described with reference to FIG. 5.

FIG. 5 is a view provided to explain purchase history information update of the electronic apparatus 100 according to yet another exemplary embodiment.

Referring to FIG. 5, the display apparatus 200 displays a shopping image 50 from a home shopping channel.

When a first button 51 of a remote controller is selected while the shopping image 50 is displayed on the display apparatus 200, an image 55 for selecting a payment means may be displayed, and when a second button 52 is selected, an image including the detailed information regarding the product is displayed.

The display apparatus 200 transmits the first characteristic information regarding the shopping image 50 to the electronic apparatus 100.

Subsequently, the processor 130 transmits content information corresponding to the received first characteristic information to the display apparatus 200. Here, the content information is information which allows the display apparatus 200 to identify the image currently displayed on the display apparatus 200.

After identifying that the image currently displayed on the display apparatus 200 is the shopping image 50 based on the content information, the display apparatus 200 may determine which image is displayed when a particular remote control signal is received from the remote controller 300.

For example, if a remote control signal corresponding to the first color button 51 is received from the remote controller 300 while the shopping image 50 is displayed on the display apparatus 200, the display apparatus 200 displays the image 55 for selecting a payment means, and transmits the second characteristic information including information which indicates that the image 55 for selecting a payment means is displayed to the electronic apparatus 100.

The processor 130 may immediately confirm that the image currently displayed on the display apparatus 200 is an image related to payment for a product purchase based on the received second characteristic information. In other words, even without the above-described operations such as the deep learning technology, the keyword recognition, the fingerprint comparison, etc., the processor 130 may immediately confirm that the image currently displayed on the display apparatus 200 is an image related to payment for a product purchase based on the received second characteristic information.

If the product information is not acquired from the second characteristic information, the processor 130 may acquire the product information from the first characteristic information which was received previously, and update the purchase history information corresponding to the display apparatus 200 based on the acquired product information. This process has been described with reference to FIG. 4 and thus, further description thereof will not be provided.

In the above exemplary embodiment, the operation of determining whether an order command is input through the remote controller 300 is performed in the display apparatus 200, but this operation may also be performed in the electronic apparatus 100. In this case, the display apparatus 200 may transmit information regarding a remote control signal to the electronic apparatus 100.

According to the above exemplary embodiment, by using a user command input to the display apparatus 200, it is more easily determined whether the image displayed on the display apparatus 200 is related to payment for a product purchase. The a user command may be input through a remote controller, but it is not limited thereto. For example, a user command may be input through a user voice, a user motion, etc.

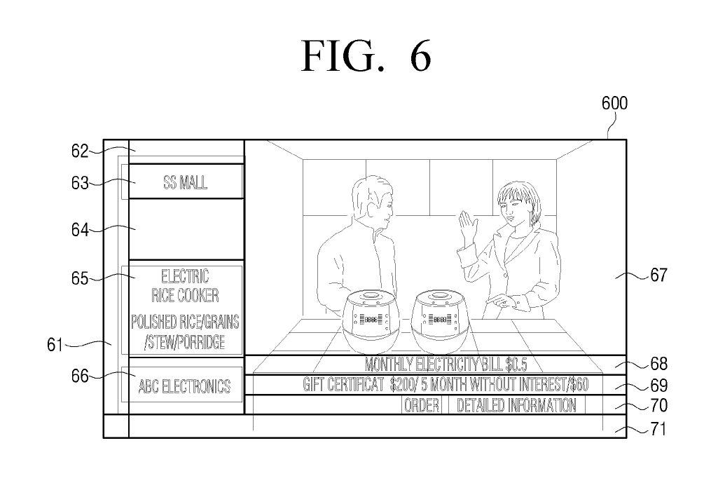

FIG. 6 is a view provided to explain an exemplary embodiment regarding generation of characteristic information corresponding to an image displayed on the display apparatus 200.

The display apparatus 200 may acquire a text from an image using Optical Character Reader (OCR), include the acquired text in characteristic information, and transmit the characteristic information to the electronic apparatus 100. Specifically, the display apparatus 200 may determine an area for performing OCR in the image, perform OCR in the determined area and acquire a text.

The display apparatus 200 may store various templates for performing OCR, and a template which is suitable for the image currently displayed may be selected. FIG. 6 is a view provided to explain an example of a template which can be applied to the shopping image illustrated in FIGS. 3 to 5.

Referring to FIG. 6, a template 600 is divided into a plurality of areas. Specifically, the template 600 is divided into a vertical blank area 61, an upper blank area 62, a media brand display area 63, an upper left blank area 64, a product name display area 65, a product brand display area 66, a product image display area 67, a product summary display area 68, a price information display area 69, a button display area 70, and a horizontal blank area 71.

The display apparatus 200 may acquire a text by performing OCR in the product name display area 65 using such a template, include the acquired text in characteristic information and transmit the characteristic information to the electronic apparatus 100. The electronic apparatus 100 ay acquire product information based on the received characteristic information.

According to another exemplary embodiment, the display apparatus 200 may transmit a capture image generated by capturing only a partial area instead of the whole area of the image displayed on the display apparatus 200 to the electronic apparatus 100 as characteristic information. For example, the display apparatus 200 may determine a capture area using a template illustrated in FIG. 6. Specifically, the display apparatus 200 may capture the product name display area 65, and transmit the generated capture image to the electronic apparatus 100 as characteristic information. The electronic apparatus 100 may acquire product information based on the received capture image.

The processor 130 may update the purchase history information of the user of the display apparatus 200 based on the acquired product information, and control the communicator 110 to transmit advertisement information corresponding to the updated purchase history information to the display apparatus 200.

The purchase history information may include at least two of home-shopping purchase history information, application purchase history information, game item purchase history information, Video On demand (VOD) purchase history information, and pay TV history information. The processor 130 may control the communicator 110 to transmit advertisement information which is determined based on at least two of the home-shopping purchase history information, the application purchase history information, the game item purchase history information, the Video On demand (VOD) purchase history information, and the pay TV history information, to the display apparatus 200.

The processor 130 may determine the advertisement information in consideration of not only the purchase history information but also viewing history information. The viewing history information may be generated based on characteristic information corresponding to the image received from the display apparatus 200.

For an example, the processor 130 may recognize the image which is viewed on the display apparatus 200 based on at least one of a capture image, a channel number, a broadcaster logo, a content name, a fingerprint, etc. included in the characteristic information transmitted from the display apparatus 200.

The processor 130 may generate viewing history information or update pre-stored viewing history information based on the recognition result.

The advertisement information which is determined based on the purchase history information along with the viewing history information may reflect the user's preferences in a more multifaceted manner.

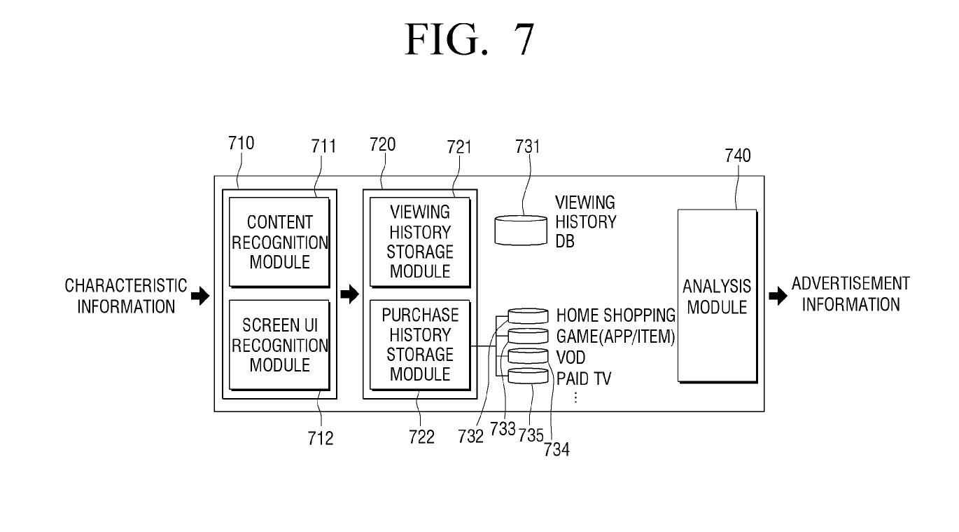

FIG. 7 is a view illustrating a data processing flow in the electronic apparatus 100 according to an exemplary embodiment.

Referring to FIG. 7, the electronic apparatus 100 includes a screen recognition unit 710 for recognizing and storing contents included in the image displayed on the display apparatus 200, a data storage 720 for analyzing the recognition result of the screen recognition unit 710 and storing the data and an analysis module 740 for analyzing the data stored in a database and providing advertisement information.

Specifically, the screen recognition unit 710 includes a content recognition module 711 and a screen UI recognition module 712. The content recognition module recognizes a content which is currently displayed on the display apparatus 200 based on a capture image, a fingerprint, a text acquired through OCR and so on. For example, the content recognition module 711 may identify a content title, a channel number, a content ID, etc. and transmit the same to the viewing history storage module 721.

The screen UI recognition module 712 may recognize a UI displayed on the display apparatus 200 based on the characteristic information. For example, the screen UI recognition module 712 may identify a product name, a product manufacturer, a product price, a payment means, a product brand, etc. by recognizing the UI and transmits the same to the purchase history storage module 722.

The data storage 720 includes the viewing history storage module 721 and the purchase history storage module 722. The viewing history storage module 721 stores viewing history in a viewing history database 731. In this case, the viewing history storage module 721 collects and enriches metadata of the contents. The examples of the metadata are as follows.

TABLE 1

| Items | Values |
|---|---|
| Channel number-major | 11 |
| Channel number-minor | 1 |
| Channel name | The Sportman Channel |
| Channel number | 308 |
| Channel type | ATSC |
| Running time | 30 |
| Finish time | 2016-08-06 18:00 |
| Episode number | 11 |
| Episode name | A |
| Content genre | Outdoors |
| Program ID | ba000000000019228668 |
| Digital or Analog | Analog |
| Whether or not to rebroadcast | FALSE |
| Finish time | 2017-03-06T18:00:00Z |
| Start time | 2017-03-06T17:30:00Z |
| Season number | 1 |
| Grade | 15+ |
| Program name | Dead Puppy Walking |
| Channel genre | Sports |
| Characters | Andrew Rincoln, John Puntal |

The purchase history storage module 722 stores purchase history in the database. In this case, the purchase history storage module 722 may divide and store purchase history according to a product category. Specifically, the purchase history database may include a home shopping purchase history database 732, a game (application, item) purchase history database 733, a VOD (drama, movie, etc.) purchase history database 734, and a pay TV purchase history database 735.

The analysis module 740 may analyze the data stored in the viewing history database 731 and the purchase history database 732, 733, 734 and 735 comprehensively, determine customized advertisement which fits the user preference, and transmit the determined advertisement information to the display apparatus 200.

Specifically, the analysis module 740 may determine advertisement information by analyzing correlation between collected data. In this case, the analysis module 740 may use the methods of Artificial Intelligence (AI), Machine Learning (ML), Data Mining (DM), etc.

For example, if the user of the display apparatus 200 has a history of purchasing women's shoes, the analysis module 740 may profile the estimated age range value and transmit advertisement information which induces product/content related purchase that is preferred by the corresponding age and gender to the display apparatus 200. Such advertisement information is, for example, advertisement information regarding shoes different from the shoes which was purchased previously, and may include the contents that a free VOD subscription for XX drama (a drama favored by women in their 20s which is the estimated age range through profiling) will be offered if a user purchases the shoes.

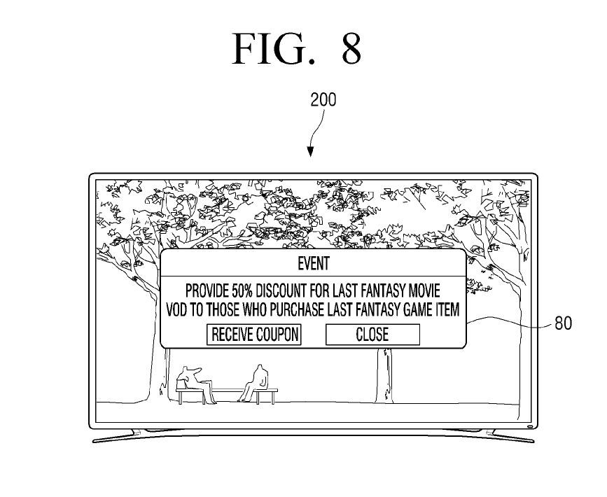

In another example, if the analysis module 740 detects that the user of the display apparatus 200 has a history of purchasing a game item frequently, advertisement information may include the contents in which the characters of the corresponding game appear. For example, if the user of the display apparatus 200 purchases an item of a fantasy game, the electronic apparatus 100 may transmit advertisement information to the display apparatus 200 such that an advertisement UI 80 is displayed as shown in FIG. 8.

In another example, if the analysis module 740 detects that the user of the display apparatus 200 has a history of watching only broadcast programs in which a specific entertainer appears, advertisement information may be transmitted to the display apparatus 200 such that a home shopping broadcast recommendation notification is displayed on the display apparatus 200 when a home shopping program broadcasts an advertisement regarding a smartphone promoted by the corresponding entertainer.

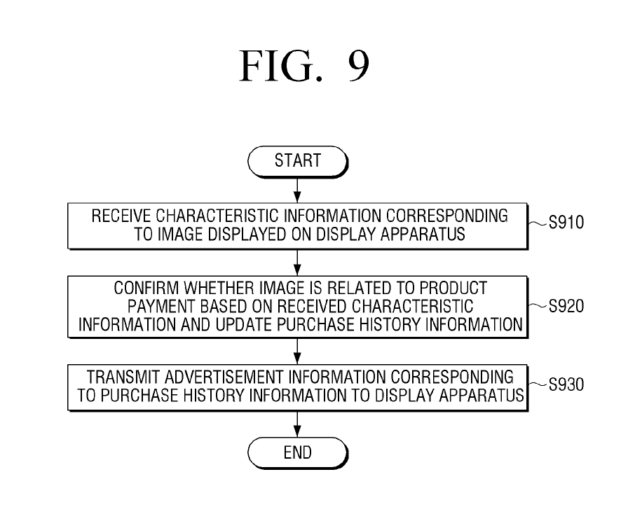

FIG. 9 is a flowchart illustrating a controlling method of an electronic apparatus according to an exemplary embodiment. The flowchart illustrated in FIG. 9 includes operations processed by the electronic apparatus 100 which has been described with reference to FIGS. 1 to 8. Accordingly, even if omitted from the following description, the features which have been described with reference to FIGS. 1 to 8 may be applied to the flowchart illustrated in FIG. 9.

Referring to FIG. 9, an electronic apparatus receives characteristic information corresponding to a first image displayed on a display apparatus (S910).

Here, the characteristic information may include at least one of a capture image which is generated by capturing the image, information regarding a fingerprint corresponding to the image, information regarding a text included in the image, and information regarding a logo included in the image.

The electronic apparatus confirms whether the image displayed on the display apparatus is related to payment for a product purchase based on the received characteristic information, and if the image is related to payment for a product purchase, updates pre-stored purchase history information (S920).

Here, the purchase history information stored in the electronic apparatus is information which reflects the purchase history of the user of the display apparatus, and may include history information regarding purchase which was made through the display apparatus and history information regarding purchase which was made through another terminal apparatus (for example, PC, smartphone, etc.) of the user, which is different from the display apparatus. The electronic apparatus may receive such information from the display apparatus or a service provider who provides a product purchase service through another terminal of the user, or such information may be received from a credit card company and the like.

For example, if the broadcaster logo included in the received characteristic information is a home shopping broadcaster logo, and texts such as “selection of payment means”, “completion of purchasing”, etc. are included in the received characteristic information, the electronic apparatus may determine that the image currently displayed on the display apparatus is related to payment for a product purchase.

Once product information is acquired from the received characteristic information, the electronic apparatus may update the purchase history information based on the acquired product information. If product information is not acquired from the received characteristic information, the electronic apparatus may acquire product information from different characteristic information which was received previously (i.e., characteristic information corresponding to an image which was displayed before the current image). This is because, in most cases, the image which was displayed before the payment image includes information regarding a purchase target product.

Then, the electronic apparatus transmits advertisement information which is determined based on the updated (or generated) purchase history information to the display apparatus (S930).

The electronic apparatus may update pre-stored viewing history information corresponding to the display apparatus based on the characteristic information received from the display apparatus. The electronic apparatus may transmit the advertisement information which is determined based on the updated viewing history information and the updated purchase history to the display apparatus.

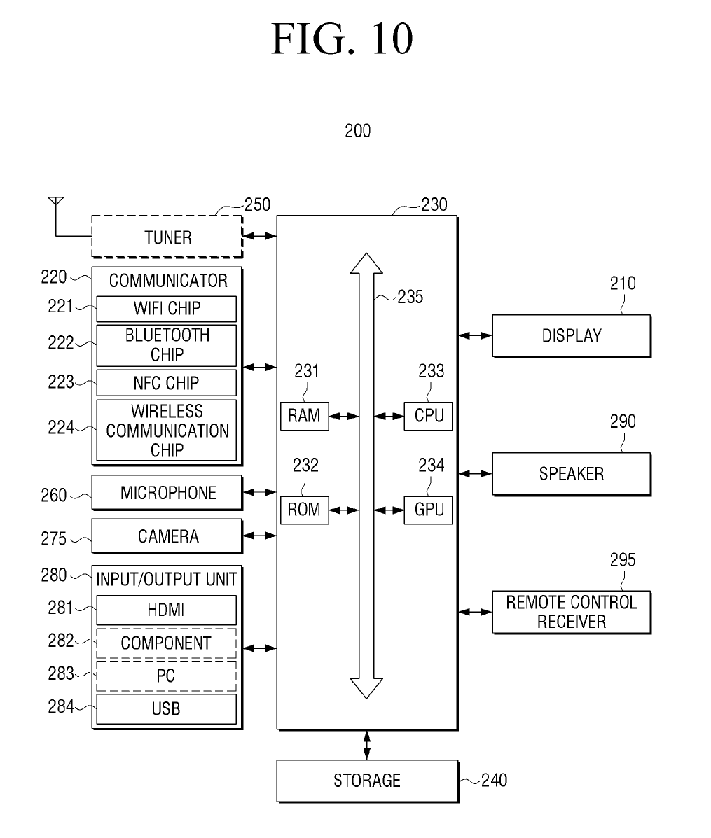

FIG. 10 is a view provided to explain configuration of the display apparatus 200 according to an exemplary embodiment.

The display apparatus 200 may be implemented as analog TV, digital TV, 3D-TV, smart TV, LED TV, OLED TV, plasma TV, monitor, curved TV having a fixed curvature of the screen, flexible TV having a fixed curvature of the screen, bended TV having a fixed curvature of the screen, and/or curvature modifiable TV in which the curvature of the current screen can be modified by the received user input. However, it may not be limited to the above.

The display apparatus 200 includes a display 210, a communicator 220, a processor 230, a storage 240, a tuner 250, a microphone 260, a camera 275, an input/output unit 280, a speaker 290, and a remote control receiver 295. The display apparatus 200 may include a sensor (for example, an illumination sensor, a temperature sensor, etc. not illustrated) for detecting the internal state or the external state of the display apparatus 200.

The display 210 is an element for displaying an image, and may be, for example, implemented as a liquid crystal display (LCD), a cathode-ray tube (CRT), a plasma display panel (PDP), an organic light emitting diode (OLED) display, a transparent OLED (TOLED) display, or the like. Also, the display 210 may be implemented in the form of a touch screen type capable of sensing a touch manipulation of a user.

The display 210 may display advertisement information received from the electronic apparatus 100.

The communicator 220 is an element which performs communication with various types of external devices according to various types of communication methods. The communicator 220 includes various communication chips such as a WiFi chip 221, a Bluetooth chip 222, an NFC chip 223, and a wireless communication chip 224. The Wi-Fi chip 221, the Bluetooth chip 222, the NFC chip 223, and the wireless communication chip 224 respectively perform communications in a Wi-Fi method, a Bluetooth method, and an NFC method. The wireless communication chip 224 means a chip that performs communication according to various communication standards such as Institute of Electrical and Electronics Engineers (IEEE), ZigBee, 3rd generation (3G), 3rd generation partnership project (3GPP), LTE, and the like.

The communicator 220 may communicate with the electronic apparatus 100. Specifically, characteristic information corresponding to the image displayed on the display 210 may be transmitted to the electronic apparatus 100 through the communicator 220, and advertisement information may be received from the electronic apparatus 100 through the communicator 220.

The processor 230 controls the overall operations of the display apparatus 200 and a signal flow between internal components of the display apparatus 200, and performs the function of processing data.

The processor 230 includes a RAM 231, a ROM 232, a CPU 233, a GPU 234, and a bus 235. The RAM 231, the ROM 232, the CPU 233, the GPU 234, etc. may be connected to each other through the bus 235. The processor 230 may, for example, be realized as a system on chip (SoC).

The CPU 233 may access the storage 240 to perform a booting using an operating system (OS) stored in the storage 240. The CPU 233 performs various operations using various programs, contents, data, etc. stored in the storage 240.

The ROM 232 may store a set of command languages, etc. for system booting. In response to a turn on command being input and power being supplied, the CPU 233 may copy an O/S stored in the storage 240 into the RAM 231 according to a command stored in the ROM 232, and boot the system by executing the O/S. If the booting is completed, the CPU 233 may copy various application programs stored in the storage 240 to the RAM 231 and execute the application programs in the RAM 231 to perform various operations.

In particular, the processor 230 may generate characteristic information corresponding to the image displayed through the display 210.

Specifically, the processor 230 may capture a video signal in a multimedia content signal received from the tuner 250 or the input/output unit 280 and transmit the captured image to the electronic apparatus 100 as characteristic information.

In addition, the processor 230 may acquire a fingerprint by capturing an audio signal or a video signal from the multimedia content signal received from the tuner 250 or the input/output unit 280. The acquired fingerprint may be transmitted to the electronic apparatus 100 as characteristic information corresponding to the image.

In addition, the processor 230 may perform OCR to acquire various information from the image displayed on the display 210, and the acquired information may be transmitted to the electronic apparatus 100 as characteristic information.

Specifically, the processor 230 may perform OCR and recognize numbers, texts, etc. to acquire information such as product name, product price, product manufacturer, product brand, name of broadcasting station, channel number, channel callsign, channel name, program name, etc. from an image related to product purchase. In this case, the processor 230 may determine an area to perform OCR based on a template for OCR stored in the storage 240, and perform OCR with respect to the determined area.

In addition, the processor 230 may acquire a logo from an image and transmit the acquired logo to the electronic apparatus 100 as characteristic information. Specifically, the processor 230 may determine an area to perform logo recognition from an image based on a template for logo recognition stored in the storage 240. Subsequently, the processor 230 may detect a logo included in the image by comparing the image included in the determined area with the logo image pre-stored in the storage 240. The processor 230 may transmit information regarding the detected logo to the electronic apparatus 100 as characteristic information corresponding to the image.

The processor 230 may control the display 210 to display advertisement information received from the electronic apparatus 100.

The storage 240 may be implemented to be non-volatile memory, volatile memory, flash memory, hard disk drive (HDD) or solid state drive (SSD). The storage 240 may be accessed by the processor 230 and may read/record/correct/delete/update data under the control of the processor 230. The storage 240 may be realized as a recording medium within the electronic apparatus 200 or as an external storage medium, such as a USB memory, a web server via network, etc. The storage 240 may store programs such as various applications and various data such as user setting data, data generated in the process of executing applications, multimedia content data, etc.

In particular, the storage 240 may store a template for generating a capture image, performing OCR or recognizing a logo, etc., and may store various logo images to be compared when performing logo recognition.

The tuner 250 may tune and select only the channel frequency to be received by the display apparatus 200 among the various wave components through the amplification, the mixing and the resonance of a broadcast signal which is received via cable or wirelessly. The broadcast signal includes video, audio, and additional data (for example, electronic program guide (EPG)).

The microphone 260 is an element capable of receiving sound. The sound that can be received through the microphone 260 may be sound in the audible or non-audible frequency bands. If the display apparatus 200 is implemented as a device capable of voice recognition, a user voice can be input through the microphone 260, and the processor 230 may perform an operation corresponding to the input voice. In this case, the processor 230 may perform voice recognition itself, or may transmit the input voice to a voice recognition electronic apparatus and receive the voice recognition result.

For example, if a user voice of “order” is input through the microphone 260 while a shopping screen 40 as illustrated in FIG. 4 is displayed on the display 210, the processor 230 may control the display 210 to display an image 45 for selecting a payment means.

The camera 275 may photograph video, and the photographed video may be used for user motion recognition. The camera 275 may be implemented integrally with or separated from the display apparatus 200. The separated camera may be electronically connected to a display apparatus 100′ through the communicator 220 or the input/output unit 280.

For example, if a user motion to select an order button is input through the camera 275 while the shopping screen 40 of FIG. 4 is displayed, the processor 230 may control the display 210 to display the image 45 for selecting a payment means.

The input/output unit 280 is an element for connecting an external apparatus. The input/output unit 280 may include at least one of a High-Definition Multimedia Interface (HDMI) input port 281, a component input jack 282, a PC input port 283, and a Universal Serial Bus (USB) input jack 284.

The remote control receiver 295 is an element for receiving an IR control signal which is output and transmitted from the remote controller 300 through an optical window. For example, if an IR control signal is received through the remote control signal receiver 295 according to a user manipulation to select an order button displayed on the shopping screen 40 in the remote controller 300 while the shopping screen 40 is displayed on the display 210, the processor 230 may control the display 210 to display the image 45 for selecting a payment means.

The remote control signal receiver 295 may receive a remote control input from a device such as a set-top box which is connected through the input/output unit, which is referred to as IR sniffing.

In the above exemplary embodiment, an image analysis is performed in the electronic apparatus 100 so that purchase history information is generated (or updated) or viewing history information is generated (or updated), but the functions of the electronic apparatus 100 may be performed in the display apparatus 200. In this case, the display apparatus 200 may generate purchase history information in itself to provide the purchase history information to an external electronic apparatus. The display apparatus 200 may be provided with advertisement information corresponding to the purchase history information from an external electronic apparatus.

According to the above-described various exemplary embodiments, the consumption pattern (i.e., which kind of product the user consumes, what kind of payment method the user prefers, whether a similar product has been purchased again, etc.) of a user may be analyzed based on pay TV, purchase of VOD content, purchase of game application items, purchase of goods in home shopping channels, etc. As such, it is possible to generate purchase history information, and the information can be used for advertising or recommendation for repurchase. In particular, by using the image recognition technology, it is possible to monitor all purchasing behaviors displayed on the screen, not just purchase history in a specific device, to confirm the comprehensive purchase history, and to configure various profit models by applying various advertisement/recommendation services.

Various exemplary embodiments described above may be embodied in a recording medium that may be readable by a computer or a similar apparatus to the computer by using software, hardware, or a combination thereof. According to the hardware embodiment, exemplary embodiments that are described in the present disclosure may be embodied by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electrical units for performing other functions. According to the software embodiment, various embodiments described in the specification such as a procedure and a function may be embodied as separate software modules. The software modules may respectively perform one or more functions and operations described in the present specification.

A program to realize the procedure and function described in the present specification may be stored in a non-transitory readable medium. For example, various exemplary embodiments according to the present disclosure may be stored in a non-transitory readable medium which can be mounted and used in various devices.

The non-transitory computer readable medium refers to a medium that stores data semi-permanently rather than storing data for a very short time, such as a register, a cache, a memory or etc., and is readable by an apparatus. Specifically, the above-described various programs may be stored and provided in a non-transitory computer readable medium such as a CD, a DVD, a hard disk, a Blu-ray disk, a universal serial bus (USB), a memory card, a ROM, or the like.

The foregoing exemplary embodiments and advantages are merely examples and are not to be construed as limiting the inventive concept. The present teaching can be readily applied to other types of apparatuses. It should be understood that various modifications may be made by those skilled in the art without departing from the spirit and scope of the present disclosure.

What is claimed is:

1. An electronic apparatus comprising:
a communicator configured to communicate with a display apparatus;
a storage configured to store purchase history information; and
a processor configured to control the communicator to transmit advertisement information which is determined based on the purchase history information to the display apparatus,
wherein the processor is further configured to receive first characteristic information corresponding to a first image displayed on the display apparatus from the display apparatus through the communicator, determine whether the first image is related to payment for a product purchase based on the received first characteristic information, and if the first image is related to the payment for the product purchase, update the purchase history information.

2. The apparatus as claimed in claim 1, wherein the first characteristic information comprises at least one of a capture image which is generated by capturing the first image, information regarding a fingerprint corresponding to the first image, information regarding a text included in the first image, and information regarding a logo included in the first image.

3. The apparatus as claimed in claim 1, wherein the processor is further configured to, if the first image is related to the payment for the product purchase and product information is acquired from the first characteristic information, update the purchase history information based on the acquired product information.

4. The apparatus as claimed in claim 1, wherein the communicator is further configured to at least one piece of second characteristic information corresponding to at least one second image which is displayed before the first image, and
wherein the processor is further configured to, if the first image is related to the payment for the product purchase and product information is not acquired from the first characteristic information, acquire product information from the received at least one piece of the second characteristic information and update the purchase history information based on the acquired product information.

5. The apparatus as claimed in claim 1, wherein the storage is further to store viewing history information corresponding to the display apparatus, and
wherein the processor is further configured to update the viewing history information based on the received first characteristic information, and control the communicator to transmit advertisement information which is determined based on the updated viewing history information and the updated purchase history information to the display apparatus.

6. The apparatus as claimed in claim 1, wherein the purchase history information comprises information regarding at least one of a product name, a product manufacturer, a product category, a product price, and a means of payment.

7. The apparatus as claimed in claim 1, wherein the storage is further configured to store a plurality of different pieces of purchase history information respectively corresponding to a plurality of display apparatuses including the display apparatus, and
wherein the processor is further configured to control the communicator to transmit a plurality of different pieces of advertisement information to each of the plurality of display apparatuses based on the plurality of different pieces of purchase history information.

8. The apparatus as claimed in claim 1, wherein the purchase history information comprises at least two of home-shopping purchase history information, application purchase history information, game item purchase history information, Video On demand (VOD) purchase history information, and pay TV history information.

9. A controlling method of an electronic apparatus, the controlling method comprising:
receiving first characteristic information corresponding to a first image displayed on a display apparatus from the display apparatus;
in response to determining that the first image is related to payment for a product purchase based on the received first characteristic information, updating pre-stored purchase history information; and
transmitting advertisement information which is determined based on the updated purchase history information to the display apparatus.

10. The controlling method as claimed in claim 9, wherein the first characteristic information comprises at least one of a capture image which is generated by capturing the first image, information regarding a fingerprint corresponding to the first image, information regarding a text included in the first image, and information regarding a logo included in the first image.

11. The controlling method as claimed in claim 9, wherein the updating comprises, if the first image is related to the payment for the product purchase and product information is acquired from the first characteristic information, updating the purchase history information based on the acquired product information.

12. The controlling method as claimed in claim 9, further comprising:
receiving at least one piece of second characteristic information corresponding to at least one second image which is displayed before the first image,
wherein the updating comprises, if the first image is related to the payment for the product purchase and product information is not acquired from the first characteristic information, acquiring product information from the received at least one piece of the second characteristic information and updating purchase history information based on the acquired product information.

13. The controlling method as claimed in claim 9, further comprising:
updating pre-stored viewing history information corresponding to the display apparatus based on the received first characteristic information,
wherein the transmitting comprises transmitting advertisement information which is determined based on the updated viewing history information and the updated purchase history information to the display apparatus.

14. The method as claimed in claim 9, wherein the purchase history information comprises information regarding at least one of a product name, a product manufacturer, a product category, a product price, and a means of payment.

15. The method as claimed in claim 9, further comprising storing a plurality of different pieces of purchase history information respectively corresponding to a plurality of display apparatuses including the display apparatus,
wherein the transmitting comprises transmitting a plurality of different pieces of advertisement information to each of the plurality of display apparatuses based on the plurality of different pieces of purchase history information.

16. The method as claimed in claim 9, wherein the purchase history information comprises at least two of home-shopping purchase history information, application purchase history information, game item purchase history information, Video On demand (VOD) purchase history information, and pay TV history information.

17. A non-transitory computer readable recording medium including a program for performing a controlling method of an electronic apparatus, wherein the controlling method comprises:
receiving first characteristic information corresponding to a first image displayed on a display apparatus from the display apparatus;
in response to determining that the first image is related to payment for a product purchase based on the received first characteristic information, updating pre-stored purchase history information; and
transmitting advertisement information which is determined based on the updated purchase history information to the display apparatus.
